(19) United States
(12) Patent Application Publication
(10) Pub. No.: US 2026/0092695 A1
(43) Pub. Date: Apr. 2, 2026

(54) SYSTEMS AND METHODS FOR PRODUCING AN OUTPUT LIGHT BEAM IRRADIATING PLANTS OR CROPS DISPOSED IN A GROWING AREA

(71) Applicant: SOLLUM TECHNOLOGIES INC., Montreal (CA)

(72) Inventors: Mikael DILLON, Montreal (CA); Alan GARCIA, Montreal (CA); Guillaume FORTIN, Montreal (CA); François R-MOISAN, Montreal (CA)

(73) Assignee: SOLLUM TECHNOLOGIES INC., Montreal (CA)

(21) Appl. No.: 19/347,126

(22) Filed: Oct. 1, 2025

Related U.S. Application Data
(60) Provisional application No. 63/701,994, filed on Oct. 1, 2024.

(51) Int. Cl. F21V 19/00; A01G 7/04; F21V 23/00; F21V 29/70; F21Y 115/10

(52) U.S. Cl. CPC F21V 19/001; A01G 7/045; F21V 23/005; F21V 29/70; F21Y 2115/10

(57) ABSTRACT

There is provided a lighting system for producing an output light beam irradiating plants or crops disposed in a plant growing area. The lighting system including: a circuit board having a relatively flat surface, the relatively flat surface extending along a plane, and including a first region and a second region. Solid-state light emitters are mounted in the first region and emitter drivers are mounted in the second region. The emitter drivers are substantially coplanar with the solid-state light emitters. The lighting system also includes a combining component configured to combine light sub-beams emitted by the solid-state light emitters into the output light beam, the output light beam having a combined spectral profile produced by a combination of individual spectra of the solid-state emitters.

### TECHNICAL FIELD

The technical field generally relates to lighting systems, and more particularly concerns systems and methods for producing an output light beam irradiating plants or crops disposed in a plant growing area.

### BACKGROUND

Lamp units developed to illuminate a space, surface or an object use different materials, designs and are applicable for multiple lighting purposes. The majority of such lamp units are now generally known to employ Light Emitting Diode (“LED”) technology as a replacement for conventional incandescent and/or fluorescent lighting to provide a lighting source that generates white light having a relatively high Colour Rendering Index (“CRI”), so that spaces, surfaces, and objects illuminated by the lighting appear as if illuminated by natural sunlight.

There is a need for a system, device, as well as methods, that can provide a desired output light beam in a reliable and efficient manner.

### SUMMARY OF THE INVENTION

In accordance with one aspect, there is provided a lighting system for producing an output light beam irradiating plants or crops disposed in a plant growing area, the lighting system including: a circuit board having a relatively flat surface, the relatively flat surface extending along a plane and including a first region and a second region; a plurality of solid-state light emitters mounted in the first region of the relatively flat surface of the circuit board, each solid-state light emitters being configured to emit a corresponding light sub-beam; a plurality of emitter drivers for controlling operation of the plurality of solid-state light emitters, each emitter driver being associated with a corresponding one of the solid-state light emitters, the plurality of emitter drivers being mounted in the second region of the relatively flat surface of the circuit board, the plurality of emitter drivers being substantially coplanar with the plurality of solid-state light emitters; and a combining component configured to combine the light sub-beams emitted by the plurality of solid-state light emitters into the output light beam, the output light beam having a combined spectral profile produced by a combination of individual spectra of the plurality of solid-state emitters.

In some embodiments, the first region of the relatively flat surface of the circuit board is contiguous with the second region of the relatively flat surface of the circuit board.

In some embodiments, the lighting system further includes a control circuit operatively connected to the plurality of emitter drivers, the control circuit including: a supplemental circuit board contacting the circuit board, the supplemental circuit board being substantially parallel to the circuit board; a controller mounted on the supplemental circuit board, the controller being configured to control driving parameters of the plurality of solid-state emitters, and a memory in communication with the controller and configured to store the driving parameters of the plurality of solid-state emitters.

In some embodiments, the solid-state light emitters are mounted on the circuit board such that the sub-beams project towards a target projection plane, the lighting system further including a housing onto which the circuit board and the supplemental circuit board are mounted, the supplemental circuit board extending between the circuit board and the target projection plane.

In some embodiments, the circuit board and the housing are substantially rectangular, the lighting system further including a thermal dissipation structure mounted on side surfaces of the housing.

In some embodiments, the thermal dissipation structure includes heat sinks defining fines extending orthogonally to the relatively flat surface of the circuit board.

In some embodiments, the control circuit is configured to control an intensity of the light sub-beam from each of the solid-state light emitters.

In some embodiments, each solid-state light emitter has an individual spectrum, the individual spectra of the solid-state light emitters collectively covering an ultraviolet portion, a visible portion and an infrared portion of the electromagnetic spectrum.

In some embodiments, the solid-state emitters are light-emitting diodes.

In some embodiments, the control circuit controls the solid-state emitters according to a Pulse Width modulation scheme.

In some embodiments, the circuit board is a printed circuit board (PCB).

In accordance with one aspect, there is provided a method for assembling a lighting system, the method including: providing a circuit board having a relatively flat surface, the relatively flat surface extending along a plane and including a first region and a second region; mounting a plurality of solid-state light emitters mounted in the first region of the relatively flat surface of the circuit board, each solid-state light emitters being configured to emit a corresponding light sub-beam; mounting a plurality of emitter drivers in the second region of the relatively flat surface of the circuit board, the plurality of emitter drivers being substantially coplanar with the plurality of solid-state light emitters, each emitter driver being associated with a corresponding one of the solid-state light emitters; and positioning a combining component for combining the light sub-beams emitted by the plurality of solid-state light emitters into the output light beam, the output light beam having a combined spectral profile produced by a combination of individual spectra of the plurality of solid-state emitters.

In accordance with one aspect, there is provided a kit for assembling a lighting system, the kit including: circuit board having a relatively flat surface, the relatively flat surface extending along a plane and including a first region and a second region; a plurality of solid-state light emitters to be mounted in the first region of the relatively flat surface of the circuit board, each solid-state light emitters being configured to emit a corresponding light sub-beam; a plurality of emitter drivers to be mounted in the second region of the relatively flat surface of the circuit board, the plurality of emitter drivers being substantially coplanar with the plurality of solid-state light emitters; and a combining component to be directly or indirectly secured to the circuit board, the combining component being configured to combine the light sub-beams emitted by the plurality of solid-state light emitters into the output light beam, the output light beam having a combined spectral profile produced by a combination of individual spectra of the plurality of solid-state emitters.

In accordance with one aspect, there is provided a circuit assembly of a lighting system for producing an output light beam irradiating plants disposed in a plant growing area, the circuit assembly including: a first circuit board extending along a first planar surface, the first circuit board including: a plurality of first footprints defined on a first planar area of the first circuit board for receiving a plurality of solid-state light emitters, the solid-state light emitters emitting a corresponding light sub-beam; and a plurality of second footprints defined on a second planar area of the first circuit board for receiving a plurality of corresponding emitter drivers, each emitter driver being associated with a corresponding one of the solid-state light emitters, the second planar area being substantially coplanar with the first planar area; and a second circuit board connected to the first circuit board, the second circuit board extending along a second planar surface substantially parallel to the first planar surface, the second circuit board including: a plurality of third footprints for receiving a controller configured to control driving parameters of the solid-state emitters and a memory in communication with the controller and storing the driving parameters.

In some embodiments, the second planar area is contiguous to the first planar area.

### BRIEF DESCRIPTION OF FIGURES

The features and advantages of the present disclosure will become apparent from the following detailed description, taken in combination with the appended drawings, in which:

FIG. 1 is an illustration of a lighting system, in accordance with some implementations of the present technology;

FIG. 2 is an exploded view of the lighting system of FIG. 1, in accordance with some implementations of the present technology;

FIG. 3 is a schematic representation of the lighting system of FIG. 1, in accordance with some implementations of the present technology;

FIG. 4 is a top plan view of a main circuit board of the lighting system of FIG. 1, in accordance with some implementations of the present technology;

FIG. 5 is a perspective view of the circuit board of FIG. 4;

FIG. 6 is a block diagram of a control circuit of the system of FIG. 1, in accordance with some implementations of the present technology; and

FIG. 7 is a flow diagram showing a method for assembling the lighting system of FIG. 1, in accordance with some implementations of the present technology.

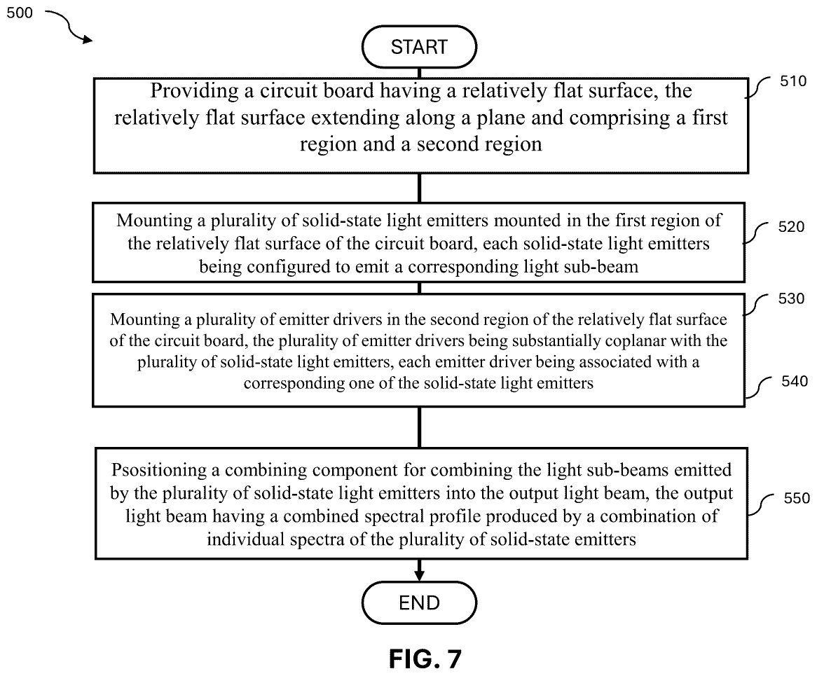

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims. It should also be noted that, unless otherwise explicitly specified herein, the drawings are not to scale.

### DETAILED DESCRIPTION

The terms “a”, “an” and “one” are defined herein to mean “at least one”, that is, these terms do not exclude a plural number of elements, unless stated otherwise. It should also be noted that terms such as “substantially”, “generally” and “about”, that modify a value, condition, or characteristic of a feature of an exemplary embodiment, should be understood to mean that the value, condition or characteristic is defined within tolerances that are acceptable for the proper operation of this exemplary embodiment for its intended application.

In the present description, the terms “connected”, “coupled”, and variants and derivatives thereof, refer to any connection or coupling, either direct or indirect, between two or more elements. The connection or coupling between the elements may be acoustical, mechanical, physical, optical, operational, electrical, wireless, or a combination thereof.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present description, the terms “light” and “optical”, and variants and derivatives thereof, are used to refer to radiation in any appropriate region of the electromagnetic spectrum. The terms “light” and “optical” are therefore not limited to visible light, but can also include, without being limited to, the infrared and ultraviolet regions. Also, the skilled person will appreciate that the definition of the ultraviolet, visible and infrared ranges in terms of spectral ranges, as well as the dividing lines between them, can vary depending on the technical field or the definitions under consideration, and are not meant to limit the scope of applications of the present techniques.

It will be appreciated that positional descriptors indicating the position or orientation of one element with respect to another element are used herein for ease and clarity of description and should, unless otherwise indicated, be taken in the context of the figures, and should not be considered limiting. It will be understood that spatially relative terms (e.g., “outer” and “inner”, “outside” and “inside” and “top” and “bottom”) are intended to encompass different positions and orientations in use or operation of the present embodiments, in addition to the positions and orientations exemplified in the figures.

The expression “natural light” is understood in the art to refer to light which has similar spectral characteristics as light of the sun reaching the earth. Such light has a natural spectral profile, defined as the variation in light intensity as a function of wavelength. As known to those skilled in the art, the spectral profile of light from the sun can vary depending of several factors such as the time of the day, the period of the year or the geographic location.

Several standards are known in the art to provide a spectral reference for natural light. For example, the Commission Internationale de L′Eclairage (hereinafter “CIE”) has established the “D” series of well-defined daylight illuminant standards representing natural light under different conditions. One well known standard is the CIE illuminant D65, which represents a midday sun in Northern/Western Europe. Other examples of CIE illuminant standards for daylight include the D50, D55 and D75 illuminant standards.

Light from the Sun includes wavelengths covering a broad spectral range from ultraviolet to infrared light. Accordingly, illuminant standards also extend over the same range. For example, the D65 illuminant standard extends from 300 nm to 830 nm.

For some applications, it may be advantageous to provide illumination which is as close as possible to sun light in the visible portion of the spectrum, so that the illumination provided is aesthetically reminiscent of being outdoors, while excluding wavelengths in the ultraviolet and infrared range which may be undesirable. The output light beam representative of a target natural light generated by lighting systems according to various embodiments of the invention may therefore span a spectral range excluding infrared and ultraviolet components, i.e. limited to visible light, or not.

It will be readily understood by one skilled in the art that the limits between the visible range and the ultraviolet and infrared ranges can vary according to the definitions considered. For example, several references in the field define the visible spectral range as extending between wavelengths of 400 nm and 720 nm, with the ultraviolet range extending between 10 nm and 400 nm and the infrared range between 720 nm and 1 mm. This convention is however given by way of example only and different wavelength ranges could be considered as target natural light in different circumstances (for example defining visible light within a spectral range between wavelengths of 380 nm and 700 nm).

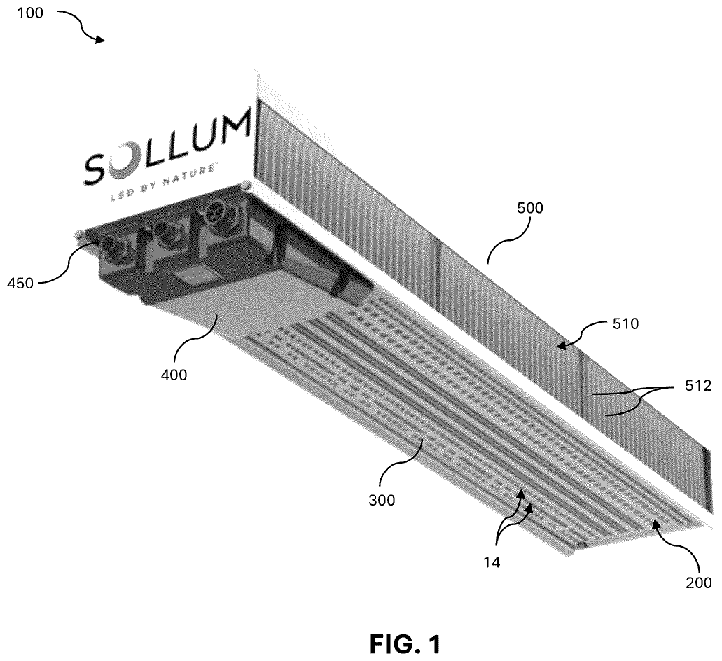

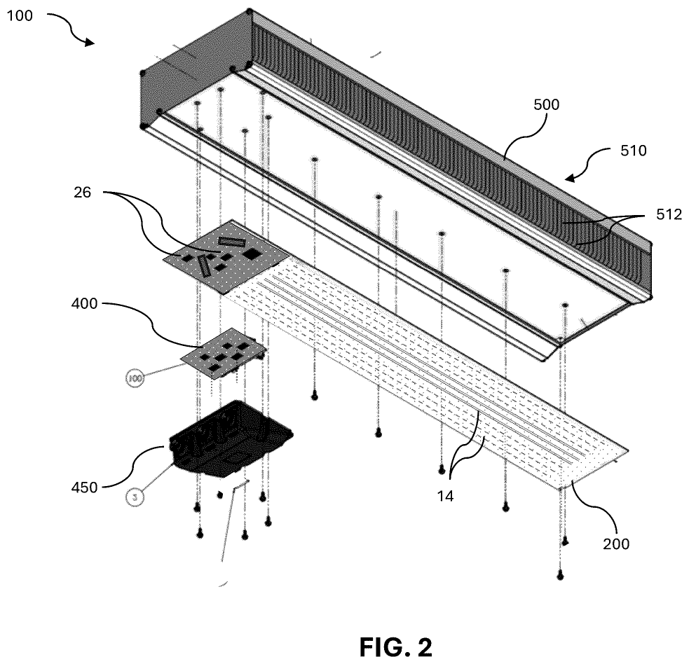

With reference to FIGS. 1 and 2, there is illustrated a lighting system 100 according to some embodiments of the present technology. The lighting system 100 includes a plurality of solid-state light emitters 14 mounted on a circuit board 200. The circuit board has a relatively flat surface, which extends along a plane, and includes a first region and a second region The solid-state light emitters 14 are configured to each emit a light sub-beam having an individual spectrum.

The solid-state light emitters 14 may be any solid state light emitting devices, such as a light emitting diode (LED), an organic light emitting diode, and/or other semiconductor light emitting device or lamp that generates light through the recombination of electronic carriers, i.e. electrons and holes, in a light emitting layer or region which may include silicon, silicon carbide, gallium nitride and/or other semiconductor materials which may or may not include a substrate such as a sapphire, silicon, silicon carbide and/or other microelectronic substrates.

The individual spectra of the solid-state light emitters 14 collectively cover a portion of the electromagnetic spectrum and may exclude other portions of the electromagnetic spectrum. Each solid-state light emitter 14 may therefore emit colored light including, blue, cyan, and/or green as well as red and/or amber etc. Of note, while in some implementations each solid-state light emitter 14 emits colored light, one or more solid-state light emitters emitting white light may also be included.

In some implementations, the individual spectrum of each solid-state emitters 14 may be selected with a center wavelength and spectral range such that it partially overlaps, and preferably overlaps at least at Full Width at Half Maximum (FWHM) or higher, with a spectrally adjacent individual spectrum. The expression “FWHM” is understood in the art to mean the extent of a function, given by the difference between the two extreme values of the independent variable at which the dependent variable is equal to half of its maximum value. In one example, the above condition may be achieved with solid state light emitters 14 illustratively selected having at most a 15 nm of difference from the centered wavelength of each other, with an average FWHM of about 30 nm. If solid state light emitters 14 with a wider spectrum are selected, such a difference between the centered wavelengths could be larger.

For example, the solid-state light emitters 14 may be grouped in one or more lines (as shown on FIGS. 1 and 2) or in a circular or rectangular pattern depending on the illumination design and surface area to be illuminated. In some embodiments, the solid-state light emitters 14 are grouped according to the wavelength at which they operate (i.e., according to their color). As another example, the lighting system 10 may be embodied in light fixtures such as recessed can lighting with the solid-state light emitters 14 grouped on a mounting plate (not shown) in clusters and/or other arrangements such that the light fixture outputs a desired directed pattern of light on a surface or object.

The lighting system 100 also includes emitter drivers 26 for controlling operation of the solid-state light emitters 14. In use, the emitter drivers 26 may convert incoming electric power, e.g. from an alternating current (AC) into direct current (DC), that is suitable for the solid states emitters 14 and control the current and voltage delivered thereto. Additionally, the emitter drivers 26 may also include protective features such as surge protection, thermal management, and short-circuit prevention, which safeguard the solid states emitters 14 from potential electrical issues. In this implementation, each emitter driver 26 is electrically connected to a corresponding solid states emitter 14 of a group of solid states emitters 14 for dedicated control thereof.

Many existing lighting systems suffer from relatively large form factor and the need for a high amount of material due to complex architecture and numerous components. Those parameters can negatively impact performance, cost, and overall efficiency of these lighting systems. Indeed, the requirement for more material increases production costs and can make the system heavier and bulkier, limiting its suitability for compact or portable applications. Complex architectures with numerous components also introduce challenges in terms of assembly, testing, and maintenance, increasing the likelihood of manufacturing defects and reducing overall reliability. Moreover, larger systems often necessitate more extensive cooling and power management solutions, which can further complicate the design and increase energy consumption. These factors combined can result in higher production and operational costs, as well as decreased system reliability.

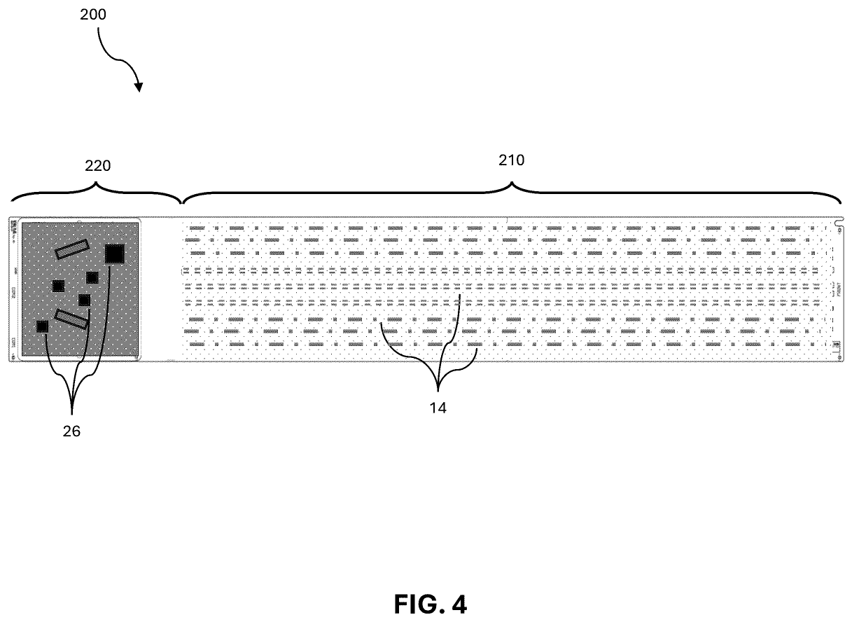

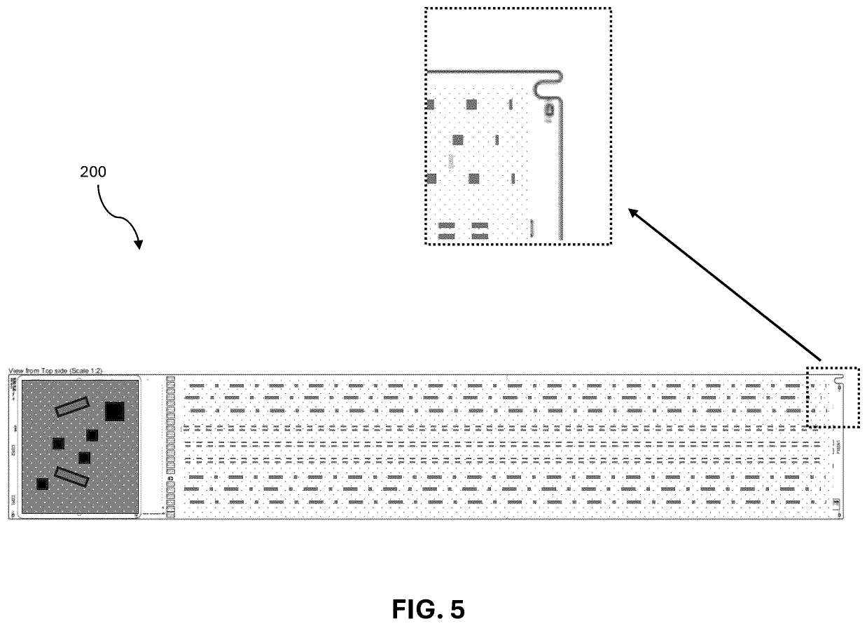

In the illustrated embodiments, the emitter drivers 26 are mounted on the circuit board 200. As best shown on FIGS. 4 and 5, the solid state emitters 14 are mounted in the first region of the relatively flat surface of the circuit board, and the emitter drivers 26 are mounted in the second region of the relatively flat surface of the circuit board, the plurality of emitter drivers being substantially coplanar with the plurality of solid-state light emitters. It can thus be said that the emitter drivers 26 and the solid states emitters 14 are positioned along a same plane on the same circuit board 200. As shown on FIGS. 4 and 5, the second region 220 is adjacent or contiguous to the first region 210. In this implementation, the circuit board 200 is substantially rectangular, but alternative planar shapes (e.g. circular) are contemplated in alternative implementations.

In some embodiments, at least some components mounted on the circuit board 200 are positioned according to a pattern. A nonlimitative example is illustrated in FIG. 4, in which the two PCB connectors are asymmetrically disposed one with respect to the other. As illustrated, the two PCB connectors are in the same plane, but do not extend along the same direction. The positioning of the two PCB connectors helps avoiding manufacturing errors. Of note, keyed connectors are not required in these embodiments.

Integrating both the solid states emitters 14 and the emitter drivers 26 on the same circuit board 200 can be highly beneficial. Indeed, this configuration minimizes the need for complex interconnections, reduces the overall system size, and simplifies the design process, signal integrity may be improved, and the risks associated with loose or faulty connections are minimized. Additionally, this integration can lead to better thermal management, as heat can be more effectively dissipated through the unified circuit board 200, enhancing the overall reliability and longevity of the lighting system 100.

As will be described in greater detail herein after, the emitter drivers 26 are communicably connected to a control circuit 400 receiving electric power from AC or DC inputs 450. The control circuit 400 and the AC or DC inputs 450 are mounted proximate to the emitter drivers 26. More specifically and as best shown on FIG. 2, the control circuit 400 is mounted below the emitter drivers 26 and substantially vertically aligned therewith.

In some embodiments, such as the one illustrated in FIGS. 4 and 5, at least one side of the circuit board 200 may include a notch. The notch may be U-shaped or V-shaped. When the lighting system 100 is assembled, a fastener, such as a screw, is provided in the notch. The profile and shape of the notch allow for deformations (e.g., elongation or contraction) of the circuit board 200, which can be a result of the heat generated by the solid-state emitters. Holes are also provided across the circuit board 200 to allow a passage of fasteners to connect or attach the components of the lighting system 100 together. Of note, the holes are typically oversized, i.e., larger than a width of the fastener, so as to allow a relative movement or displacement between the components of the lighting system 100.

The lighting system 100 typically includes a housing 500 to protect other components of the lighting system 100 from external and/or environmental potential hazards. The circuit board 200 may be mounted within or on the housing 500. As such, the housing 500 may also be referred to as a “support structure”. In this implementation, the housing 500 is substantially rectangular and includes thermal dissipation structure 510 mounted on side surfaces of the housing 500. For example, the thermal dissipation structure 510 may include fins 512 extending from lateral surfaces of the housing 500. Air flowing between the fins 512 thus collects thermal energy from the lighting system 100 and carries said thermal energy away therefrom.

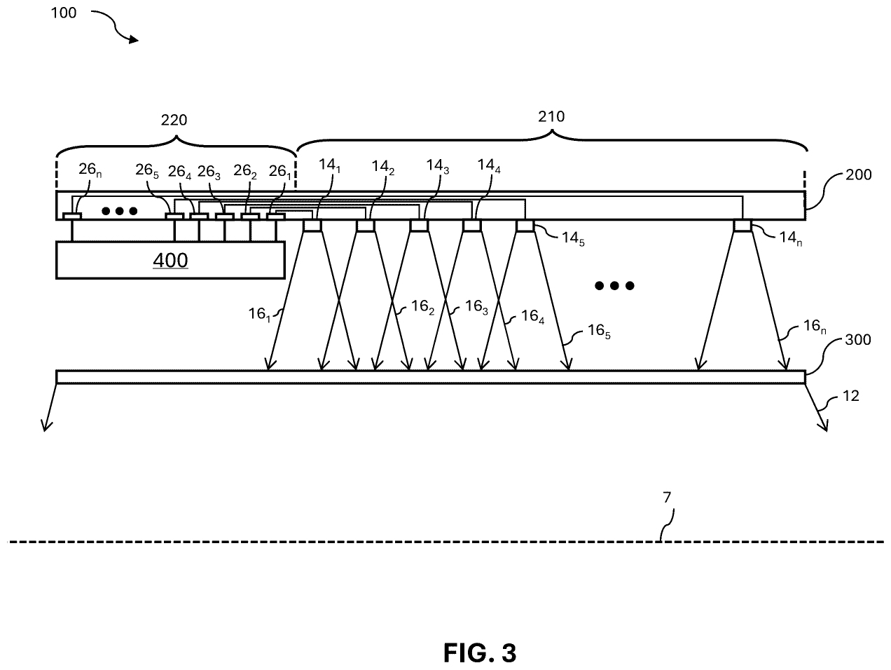

With additional reference to FIG. 3, the solid states emitters 14 are designed to each emit a light sub-beam 16 having an individual spectrum. The lighting system 100 further includes a combining component 300 combining the light sub-beams 16i from the solid-state light emitters 14i into an output light beam 12. The combining component 300 is mounted onto the housing 500 such that the circuit board 200 is at least partly enclosed between the housing 500 and the combining component 300.

The combining component 300 is configured such that the resulting output light beam 12 has a combined spectral profile defined by a combination of the individual spectra of the plurality of solid-state emitters 14i. The combining component 300 may include any one or combination of mechanical component and/or optical components cooperating to substantially mix the light sub-beams 16i together such that the output light beam 12 is projected toward a target projection plane. For example, the combining assembly 300 may include a diffuser which may be embodied by any optical component or combination of components blending light of the sub-beams 16i into the output beam 12. The diffuser may for example be embodied by sandblasted glass or plastic or other types of light mixing optics. The diffuser may be oriented or directed to illuminate an object or surface with the output light beam 12.

In some variants, for example if the object or surface to be illuminated is sufficiently distanced from the lighting system 100, the combining assembly may omit components to blend the light from the individual solid-state 14 together and simply direct the light sub-beams 16 a same optical path. In one example the light emitted by each solid-state light emitter 14 may be directed by angled reflectors (not shown). Also, while the lighting system 100 described herein eliminates the necessity of employing filters to limit the light passband to remove IR and UV components, filters or coatings (not shown) on the solid-state light emitters 14 or the combining component 300 may be provided for such a purpose, or for creating different spectra of light.

Still referring to FIGS. 1 to 3, the lighting system 100 may further include, in some embodiments, a control circuit 400 configured for controlling an intensity of the light sub-beam 16i from each of the solid-state light emitters 14i. To do so, the control circuit is operatively connected to the emitter drivers 26. In use, the control circuit 400 may transmit driving parameters as signals to each emitter driver 26i and causes the emitter driver 26i to supply a corresponding current to the corresponding solid-state light emitter 14i to generate or output the light sub-beam 16i. In this implementation, the control circuit 400 is mounted on a supplemental board that is independent from the circuit board 200.

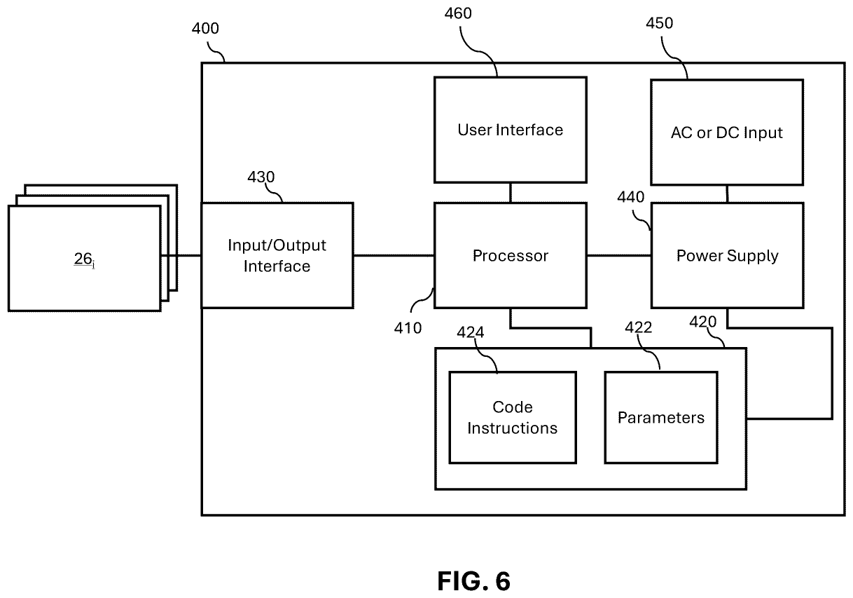

As an example, FIG. 6 is a schematic block diagram of the control circuit 400 of the according to an implementation of the present technology. The control circuit 400 comprises a processor 410 (or micro-controller, for example an ATmega328, Intel 8051, PIC, a Texas Instruments MSP430, or an ARM processor), a memory device 420, and an input/output interface 430 allowing the control circuit 400 to communicate with other components of the lighting system 100 and/or other components in remote communication therewith. The input/output interface 430 may be configured to allow the memory device 420 and/or processor 410 to be externally programmed via one or more communication protocols for example using a Universal Serial Bus (USB), Inter-Integrated Circuit (I2C), firewire, ethernet, Wi-Fi, ZigBee, or Bluetooth protocols. The programming of the memory device 420 and/or processor 410 can be performed locally on the lighting system 100, for example via the communications interface 32, or remotely by providing a remote connection over wire or wirelessly.

The processor 410 is operatively connected to the memory device 420 and to the input/output interface 430. The control circuit 400 is operatively connected, via the input/output interface 1220, to the emitter drivers 26.

The memory device 420 includes a storage for storing parameters 422, including for example and without limitation the above-mentioned spectral profile of a target natural light and driving parameters for the emitter drivers 26. The memory device 420 may comprise a non-transitory computer-readable medium for storing code instructions 424 that are executable by the processor 410 to allow the control circuit 400 to perform the various tasks allocated to the control circuit 400 described herein. The memory device 420 may include for example volatile and non-volatile computer memory such as RAM, PROM, EPROM, and EEPROM flash memory. Of note, while the memory device 420 may be provided to store the various drive parameters and other processor settings such as the built-in mathematical equations and solid-state light emitter parameter database (not shown) which allow for the lighting system 100 to be tunable, the processor 410 may alternatively be set to drive the solid-state light emitters 14 to generate only a single combined spectral profile, without requiring the memory device 420. The memory device 420 may illustratively be encoded with one or more software programs that, when executed on the controller 24, perform at least some of the functions discussed herein. The memory device 420 may be permanently connected to the processor 410 or may be removable and transportable, so that more programs stored thereon can be executed by the processor 410 so as to control the various combined spectral profiles. Of note, the terms “program” or “computer program” is used in a generic sense to refer to any type of computer code (e.g. software or microcode) that can be employed to program one or more processors 410.

Still referring to FIG. 6, the control circuit 400 may also include a power supply 440 which receives power from the AC or DC input 450 and supplies rated voltages to the associated components forming the control circuit 400.

Still referring to FIG. 6, a user interface 460 which may send user control signals to the processor 410 may also be included in the control circuit 400. For example, the user interface 460 may include a dimmer switch which sends a dimming signal to the processor 410 which in turn calculates a lumen proportion needed for emissions from each solid-state light emitters 14 so that the combined spectral profile stays representative of the target natural light. The processor 410 may also calculate the minimum number of solid-state light emitters 14 and electric current to be supplied by the emitter drivers 26 needed to achieve the target CCTs and CRI while maximizing the lumen output in order to enhance the luminaire efficacy as specified by the ENERGY STAR® program.

Broadly speaking, the control circuit 400 may be embodied by any one or combination of devices, hardware, software, circuits, processors, and other components adapted to carry out the control of the individual intensities and voltages of the solid-state light emitters 14i. FIG. 6 as illustrated represents a non-limiting implementation in which the control circuit 400 orchestrates operations of the lighting system 100. This particular implementation is not meant to limit the present disclosure and is provided for illustration purposes.

In some implementations, the solid-state light emitter 14 generates or outputs light when a current is driven across a p-n junction in the semiconductor diode (not shown) thereof. The intensity of the light generated is thus correlated to the amount of current driven through the diode. In one variant, the control circuit 400 controls the solid-state emitters 14 according to a Pulse Width Modulation (PWM) scheme, a known method for controlling the current driven through a diode to achieve desired intensity and/or color mixing. A PWM scheme alternately pulses the solid-state light emitter 14 to a full current “ON” state followed by a zero current “OFF” state. Depending on the command that is given, by controlling the variation of the duty cycle (0-100%), the average luminous power emitted by the solid-state emitter 14 proportionally increases or decreases. The intensity and the temperature of solid-state emitter 14 may thus be controlled by the PWM signals issued to the plurality of emitter drivers 26 by the controller 24.

Each emitter driver 26 may then send its own PWM current pulse to its associated solid-state emitter 14. The luminous intensity of the resultant output light sub-beams 16 may be individually adjusted by independently applying particular drive currents to the respective solid-state light emitters according to the control signals from the controller 24. Thus, the intensity of each solid-state light emitter 14 may be adjusted to power the solid-state light emitters 14 high or low for generating the output light beam 12. The controller 24 is able to individually control the plurality of driving signals from each emitter driver 26 to a respective solid-state light emitter 14 so that the resulting combined spectral profile of the output light beam is representative of the natural light spectral profile of the target natural light over said visible portion. Additionally, since each spectrum 20 can be more accurately controlled by the controller 24, energy can be conserved. In accordance with one embodiment of the invention, the frequencies of the PWM signal may also be adjustable in the ranges between 100 Hz to 10 kHz for implementing lighting functions, such as dimming for example. A high PWM frequency may be utilized (e.g., between 150 Hz and 1 KHz) such that the on and off flickering of the solid-state light emitters 14 is generally not perceptible to the naked eye.

In some embodiments, the first region of the relatively flat surface of the circuit board is contiguous with the second region of the relatively flat surface of the circuit board.

In some embodiments, the lighting system further comprises a control circuit operatively connected to the plurality of emitter drivers, the control circuit comprising: a supplemental circuit board contacting the circuit board, the supplemental circuit board being substantially parallel to the circuit board; a controller mounted on the supplemental circuit board, the controller being configured to control driving parameters of the plurality of solid-state emitters, and a memory in communication with the controller and configured to store the driving parameters of the plurality of solid-state emitters.

In some embodiments, the solid-state light emitters are mounted on the circuit board such that the sub-beams project towards a target projection plane, the lighting system further comprising a housing onto which the circuit board and the supplemental circuit board are mounted, the supplemental circuit board extending between the circuit board and the target projection plane.

In some embodiments, the circuit board and the housing are substantially rectangular, the lighting system further comprising a thermal dissipation structure mounted on side surfaces of the housing.

In some embodiments, the thermal dissipation structure comprises heat sinks defining fines extending orthogonally to the relatively flat surface of the circuit board.

In some embodiments, the control circuit is configured to control an intensity of the light sub-beam from each of the solid-state light emitters.

In some embodiments, each solid-state light emitter has an individual spectrum, the individual spectra of the solid-state light emitters collectively covering an ultraviolet portion, a visible portion and an infrared portion of the electromagnetic spectrum.

In some embodiments, the solid-state emitters are light-emitting diodes.

In some embodiments, the control circuit controls the solid-state emitters according to a Pulse Width modulation scheme.

In some embodiments, the circuit board is a printed circuit board (PCB). In some embodiments, the circuit board is formed of conductive paths directly printed on a surface of the heat sink or at least a portion of the thermal dissipation structure. In these embodiments, the conductive paths may be anodized or covered by an insulator, so as to be electrically insulated.

In accordance with one aspect, there is provided a method for assembling a lighting system, the method comprising: providing a circuit board having a relatively flat surface, the relatively flat surface extending along a plane and comprising a first region and a second region; mounting a plurality of solid-state light emitters mounted in the first region of the relatively flat surface of the circuit board, each solid-state light emitters being configured to emit a corresponding light sub-beam; mounting a plurality of emitter drivers in the second region of the relatively flat surface of the circuit board, the plurality of emitter drivers being substantially coplanar with the plurality of solid-state light emitters, each emitter driver being associated with a corresponding one of the solid-state light emitters; and positioning a combining component for combining the light sub-beams emitted by the plurality of solid-state light emitters into the output light beam, the output light beam having a combined spectral profile produced by a combination of individual spectra of the plurality of solid-state emitters.

In accordance with another aspect, there is provided a kit for assembling a lighting system, the kit comprising: a circuit board having a relatively flat surface, the relatively flat surface extending along a plane and comprising a first region and a second region; a plurality of solid-state light emitters to be mounted in the first region of the relatively flat surface of the circuit board, each solid-state light emitters being configured to emit a corresponding light sub-beam; a plurality of emitter drivers to be mounted in the second region of the relatively flat surface of the circuit board, the plurality of emitter drivers being substantially coplanar with the plurality of solid-state light emitters; and a combining component to be directly or indirectly secured to the circuit board, the combining component being configured to combine the light sub-beams emitted by the plurality of solid-state light emitters into the output light beam, the output light beam having a combined spectral profile produced by a combination of individual spectra of the plurality of solid-state emitters.

In accordance with another aspect, there is provided a circuit assembly of a lighting system for producing an output light beam irradiating plants disposed in a plant growing area, the circuit assembly comprising: a first circuit board extending along a first planar surface, the first circuit board comprising: a plurality of first footprints defined on a first planar area of the first circuit board for receiving a plurality of solid-state light emitters, the solid-state light emitters emitting a corresponding light sub-beam; and a plurality of second footprints defined on a second planar area of the first circuit board for receiving a plurality of corresponding emitter drivers, each emitter driver being associated with a corresponding one of the solid-state light emitters, the second planar area being substantially coplanar with the first planar area; and a second circuit board connected to the first circuit board, the second circuit board extending along a second planar surface substantially parallel to the first planar surface, the second circuit board comprising: a plurality of third footprints for receiving a controller configured to control driving parameters of the solid-state emitters and a memory in communication with the controller and storing the driving parameters,

In some embodiments, the second planar area is contiguous to the first planar area.

It will be readily understood that the natural light spectral profile of the target natural light may be determined or selected in a variety of manners depending on the intended use of the lighting system. In some embodiments, the natural light spectral profile may match a daylight spectral distribution standard such as the D65 standard from the CIE. Other standards of interest may include the D50, D55 and D75 standards as well as the A, B, C or D standards. It will be readily understood that these standards are meant to represent natural light in a particular location on Earth at a particular time of a particular day of the year. It is well known that the spectrum of natural light varies according to seasons, time of day and physical location. Accordingly, in alternative embodiments the natural light spectral profile of the target natural light may be selected according to any desired natural light output. This may for example be realized by acquiring the spectrum of outdoors ambient light at the location, time and season of interest and using the collected information as the target light.

The natural light spectral profile may be associated with a given color temperature (in Kelvin degrees), as known in the art. The color temperature of a light source may be defined as the temperature of an ideal black-body radiator that radiates light of comparable hue to that light source. Characterizing light from the sun according to color temperature is often considered a valid approximation as the sun can be considered close to an ideal black-body radiator. The color temperature of the D65 standard is about 6500K.

Of note, the output light beam does not need to be an exact match to the natural light spectral profile of the target natural light over the visible and/or non-visible portions of the electromagnetic spectrum in order to be considered “representative” of the same. In some embodiments, it may suffice that the general shape of the natural light spectral profile be reproduced in order for the eye to perceive the same “color” or “shade” of white. Eye perception can vary from one individual to the next. In some embodiments, the combined spectral profile of the output light beam may be considered representative of the natural light spectral profile of the target natural light if both spectral profiles match over the visible portion within a 5% error range.

The different light emitter have partially overlapping spectra, such that the addition of all of these spectra covers the entire visible range, while excluding infrared and ultraviolet wavelengths. It will be readily understood that the term “excluding” in this context is not meant to refer to a mathematical value of zero light intensity within the UV and IR range, but that any light components within these ranges are weak enough to be negligible with respect to the portion of the light in the visible range, and/or that UV and IR components are too small to impart significant damages to objects being lighted in the target application of the lighting system.

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the scope of the appended claims.

1. A lighting system for producing an output light beam irradiating plants or crops disposed in a plant growing area, the lighting system comprising:
a circuit board having a relatively flat surface, the relatively flat surface extending along a plane and comprising a first region and a second region;
a plurality of solid-state light emitters mounted in the first region of the relatively flat surface of the circuit board, each solid-state light emitters being configured to emit a corresponding light sub-beam;
a plurality of emitter drivers for controlling operation of the plurality of solid-state light emitters, each emitter driver being associated with a corresponding one of the solid-state light emitters, the plurality of emitter drivers being mounted in the second region of the relatively flat surface of the circuit board, the plurality of emitter drivers being substantially coplanar with the plurality of solid-state light emitters; and
a combining component configured to combine the light sub-beams emitted by the plurality of solid-state light emitters into the output light beam, the output light beam having a combined spectral profile produced by a combination of individual spectra of the plurality of solid-state emitters.

2. The lighting system of claim 1, wherein the first region of the relatively flat surface of the circuit board is contiguous with the second region of the relatively flat surface of the circuit board.

3. The lighting system of claim 1, further comprising a control circuit operatively connected to the plurality of emitter drivers, the control circuit comprising:
a supplemental circuit board contacting the circuit board, the supplemental circuit board being substantially parallel to the circuit board;
a controller mounted on the supplemental circuit board, the controller being configured to control driving parameters of the plurality of solid-state emitters, and
a memory in communication with the controller and configured to store the driving parameters of the plurality of solid-state emitters.

4. The lighting system of claim 3, wherein the solid-state light emitters are mounted on the circuit board such that the sub-beams project towards a target projection plane, the lighting system further comprising a housing onto which the circuit board and the supplemental circuit board are mounted, the supplemental circuit board extending between the circuit board and the target projection plane.

5. The lighting system of claim 4, wherein the circuit board and the housing are substantially rectangular, the lighting system further comprising a thermal dissipation structure mounted on side surfaces of the housing.

6. The lighting system of claim 5, wherein the thermal dissipation structure comprises heat sinks defining fines extending orthogonally to the relatively flat surface of the circuit board.

7. The lighting system of claim 3, wherein the control circuit is configured to control an intensity of the light sub-beam from each of the solid-state light emitters.

8. The lighting system of claim 7, wherein each solid-state light emitter has an individual spectrum, the individual spectra of the solid-state light emitters collectively covering an ultraviolet portion, a visible portion and an infrared portion of the electromagnetic spectrum.

9. The lighting system of claim 1, wherein the solid-state emitters are light-emitting diodes.

10. The lighting system of claim 3, wherein the control circuit controls the solid-state emitters according to a Pulse Width modulation scheme.

11. The lighting system of claim 1, wherein the circuit board is a printed circuit board (PCB).

12. A method for assembling a lighting system, the method comprising:
providing a circuit board having a relatively flat surface, the relatively flat surface extending along a plane and comprising a first region and a second region;
mounting a plurality of solid-state light emitters mounted in the first region of the relatively flat surface of the circuit board, each solid-state light emitters being configured to emit a corresponding light sub-beam;
mounting a plurality of emitter drivers in the second region of the relatively flat surface of the circuit board, the plurality of emitter drivers being substantially coplanar with the plurality of solid-state light emitters, each emitter driver being associated with a corresponding one of the solid-state light emitters; and
positioning a combining component for combining the light sub-beams emitted by the plurality of solid-state light emitters into the output light beam, the output light beam having a combined spectral profile produced by a combination of individual spectra of the plurality of solid-state emitters.

13. A kit for assembling a lighting system, the kit comprising:
a circuit board having a relatively flat surface, the relatively flat surface extending along a plane and comprising a first region and a second region;
a plurality of solid-state light emitters to be mounted in the first region of the relatively flat surface of the circuit board, each solid-state light emitters being configured to emit a corresponding light sub-beam;
a plurality of emitter drivers to be mounted in the second region of the relatively flat surface of the circuit board, the plurality of emitter drivers being substantially coplanar with the plurality of solid-state light emitters; and
a combining component to be directly or indirectly secured to the circuit board, the combining component being configured to combine the light sub-beams emitted by the plurality of solid-state light emitters into the output light beam, the output light beam having a combined spectral profile produced by a combination of individual spectra of the plurality of solid-state emitters.

14. A circuit assembly of a lighting system for producing an output light beam irradiating plants disposed in a plant growing area, the circuit assembly comprising:
a first circuit board extending along a first planar surface, the first circuit board comprising:
a plurality of first footprints defined on a first planar area of the first circuit board for receiving a plurality of solid-state light emitters, the solid-state light emitters emitting a corresponding light sub-beam; and
a plurality of second footprints defined on a second planar area of the first circuit board for receiving a plurality of corresponding emitter drivers, each emitter driver being associated with a corresponding one of the solid-state light emitters, the second planar area being substantially coplanar with the first planar area; and
a second circuit board connected to the first circuit board, the second circuit board extending along a second planar surface substantially parallel to the first planar surface, the second circuit board comprising:
a plurality of third footprints for receiving a controller configured to control driving parameters of the solid-state emitters and a memory in communication with the controller and storing the driving parameters.

15. The circuit assembly of claim 14, wherein the second planar area is contiguous to the first planar area.
